(19) United States
(12) Patent Application Publication
(10) Pub. No.: US 2024/0212944 A1
(43) Pub. Date: Jun. 27, 2024

(54) ALUMINUM ELECTROLYTIC CAPACITOR INTEGRATED MODULE

(71) Applicant: Wanglong ZHOU, Shenzhen (CN)

(72) Inventor: Wanglong ZHOU, Shenzhen (CN)

(21) Appl. No.: 18/571,147

(22) PCT Filed: Dec. 15, 2021
(86) PCT No.: PCT/CN2021/138356

§ 371 Date: Dec. 15, 2023

(30) Foreign Application Priority Data
Jan. 15, 2021 (CN) 202110052679.9
Jan. 15, 2021 (CN) 202110059121.3
Jan. 15, 2021 (CN) 202110059122.8
Feb. 10, 2021 (CN) 202110186402.5
Feb. 19, 2021 (CN) 202110195101.9
Feb. 19, 2021 (CN) 202110195103.8

(51) Int. Cl. H01G 9/00; H01G 9/008; H01G 9/10; H01G 9/14; H01G 9/26

(52) U.S. Cl. CPC H01G 9/0003; H01G 9/008; H01G 9/10; H01G 9/14; H01G 9/26

(57) ABSTRACT

An aluminum electrolytic capacitor integrated module which is good in heat dissipation, low in temperature rise, long in operating life and capable of retraining EMI noise, is formed by integrating separate aluminum electrolytic capacitors and realizes centralized insulation and heat conduction by heat-conducting insulation gasket, such that efficient cooling is realized through a radiator; secondary sealing is performed on sealed positions of the separate aluminum electrolytic capacitors, thus breaking through the 15-year upper limit of the operating life of the capacitor module; a temperature sensor is arranged to monitor the internal temperature rise and operating life in real time; a Y capacitor module is arranged to solve the reverse pulse current formation of negative foil by an electrolyte in the capacitors under high-order harmonics on a power DC busbar; and common mode interference is effectively restrained, thus improving the EMC reliability of a whole electronic system.

### BACKGROUND OF THE PRESENT INVENTION

The invention relates to a novel packaged aluminum electrolytic capacitor structure (aluminum electrolytic capacitor module), in particular to an aluminum electrolytic capacitor integrated module, which is formed by integrating separate aluminum electrolytic capacitors, adopt radiators for cooling, uses a temperature sensor to monitor the temperature rise in the capacitor module, and is integrated with Y capacitors to optimize the EMC performance of a power supply device, such that the performance and reliability of the aluminum electrolytic capacitor integrated module are improved when the aluminum electrolytic capacitor integrated module is applied to switching power supplies, inverters, frequency converters, or other power electronic devices.

### DESCRIPTION OF RELATED ARTS

Switching power supplies, inverters, frequency converters, or other power electronic devices regulate the output voltage and frequency by means of on/off of IGBT/MOSFET semiconductor devices, and a desired supply voltage can be provided for these power electronic devices according to the actual demand of a load to fulfill the purpose of energy saving and control. In order to balance and retrain busbar voltage fluctuations, a large number of high-capacity aluminum electrolytic capacitors are used for filtering to stabilize the voltage.

Generally, aluminum electrolytic capacitors are packaged separately, and comprise products which adopt lead-out structures based on leads, soldering terminals, bolts or the like, and users connect the aluminum electrolytic capacitors in series or parallel to combine various performance parameters to adapt to indicators such as voltage, ripple current, correction frequency and temperature coefficient and to form a capacitor bank applied to industrial equipment and various electronic products.

The operating life of aluminum electrolytic capacitors is determined by the central hot-spot temperature, and the operating life of the aluminum electrolytic capacitors will decrease with the rise of the hot-spot temperature. In general cases, the operating life of the aluminum electrolytic capacitors will be prolonged by one time every time the hot-spot temperature is decreased by 5-10° ° C.

Generally, manufacturers test the internal operating temperature of aluminum electrolytic capacitors by means of K-type or J-type thermocouples inlaid in the aluminum electrolytic capacitors, users test the operating temperature of the aluminum electrolytic capacitors by means of NTC or PTC the rmistors attached to the surface of the aluminum electrolytic capacitors, and the temperature rise of the aluminum electrolytic capacitors is detected to predict the operating life of the aluminum electrolytic capacitors and realize high-temperature protection and monitoring of the aluminum electrolytic capacitors.

In a case where separate aluminum electrolytic capacitors are used, the temperature of all the aluminum electrolytic capacitors needs to be monitored, the monitoring process is complex, and the monitoring cost is high, so a branch of aluminum electrolytic capacitors close to the center of the capacitor bank are selected and used for sample monitoring. However, there are great errors between temperature data results obtained by sample monitoring and actual temperature data of the aluminum electrolytic capacitors, and particularly, in case of a quality fault of the aluminum electrolytic capacitors used for sample monitoring, obtained data results will be completely unable to reflect the actual operating temperature rise of the aluminum electrolytic capacitors.

The life of aluminum electrolytic capacitors will be greatly impacted by service conditions, such as environmental conditions including temperature, humidity, air pressure, vibrations and the like, and electrical conditions including voltage, ripple current, charge-discharge and the like. When aluminum electrolytic capacitors are used for filtering of power busbars, heat generated by temperature and ripple current is an important determinant of the operating life of the capacitors, and is mainly affected by evaporation of an electrolyte through sealed parts, reflected by a decrease of the electrostatic capacity and an increase of the tangent value of a loss angle.

Due to the evaporation of the electrolyte and aging of rubber materials of sealed parts of capacitors, the presumed upper limit of the operating life of the aluminum electrolytic capacitors is generally 15 years.

A power supply device applied to capacitors is cooled typically by an IGBT/MOSFET power semiconductor device, and other passive elements such as aluminum electrolytic capacitors are cooled through direct ventilation by means of fans. However, in some special application environments requiring a high outdoor protection level over IP65 such as string inverters and module power supplies for charging piles, a protective housing should be dust-proof, water-proof and isolated from the outside, which limits air ventilation, so the passive elements cannot be cooled through direct ventilation anymore. Particularly, with the continuous increase of the power density of the power supply device, the heat dissipation requirement of the aluminum electrolytic capacitors used for filtering of the busbars of the main circuit will become increasingly higher. However, due to the large power loss and high operating temperature of the IGBT/MOSFET device, the radiator configured for the power supply device cannot cool the power semiconductor device and the capacitors at the same time, so for the aluminum electrolytic capacitors, it is an issue to be settled by engineers to realize cooling outside the airtight housing with the protection level over IP65.

PWM commonly used for power electronic devices will lead to the superposition of high-order harmonics at the output terminal, which will in turn cause differential mode interference at the output terminal, and from the aspect of the propagation route of differential mode current, the differential mode current is propagated mainly on the positive and negative poles of a DC busbar on the input side and AC cables. At the moment an IGBT/MOSFET is turned on or off, high Du/Dt will be generated and pass through switching devices in the circuit, ground parasitic capacitors of metal leads, cooling fins and the housing will be continuously charged and discharged to generate common mode currents, and radiated interference will be caused by the differential mode currents and the common mode currents. Due to the fact that the high-order harmonics on the power DC busbar cannot be effectively absorbed or filtered out by aluminum electrolytic capacitors, reverse pulse current formation will be caused to negative foil by the electrolyte in the aluminum electrolytic capacitors, and a large amount of gas and heat will be generated, leading to earlier aging of the capacitors.

In addition, a power wire in the power electronic device will produce strong radiation to form an efficient radiation antenna; when a power electronic system operates, a loop formed by differential mode currents will form a loop antenna, which radiates electromagnetic interference outwards; generally, the power electronic device uses a metal housing for electromagnetic shielding, slots in the metal housing will form slot antennas, which radiate electromagnetic interference outwards; the existence of a large amount of radiated noise interference signals not only affects radio equipment around the power electronic device, but also compromises the operating reliability of an electronic control unit of the power electronic device, particularly the electronic control unit, with high electromagnetic sensitivity, in high-voltage and high-power power electronic device systems, worsening the EMC program. Generally, safety capacitors are used for preventing electric shocks to protect personnel safety, X capacitors are used for restraining differential mode interference of circuits, and Y capacitors are used for restraining common mode interference of circuits.

The electrical performance of an independent and integrated aluminum electrolytic capacitor module formed by integrating separate aluminum electrolytic capacitors can be optimized. For example, the electrical performance, such as ripple current capacity and high-frequency characteristic, of a small aluminum electrolytic capacitor integrated module in Patent 202011082745.9 or in Patent 202011082897.9 is greatly improved.

Because the aluminum shells of aluminum electrolytic capacitors have negative voltage, the aluminum electrolytic capacitors should be isolated from a metal heat-conducting base component when the aluminum electrolytic capacitors are integrated to form an aluminum electrolytic capacitor module; and because the aluminum electrolytic capacitors have a special pressure release fault mode, an internal pressure release guarantee mechanism should be set in the aluminum electrolytic capacitor module.

Generally, PVC or PET insulating bushings are disposed outside the aluminum shells of the separate aluminum electrolytic capacitors to realize insulation, the separate aluminum electrolytic capacitors and the metal heat-conducting base components in the aluminum electrolytic capacitor module are isolated by means of heat-conducting silica gel, and in order to improve the insulation reliability, thick heat-conducting silica gel should be used; however, in order to improve the heat dissipation performance of the capacitor module, the heat resistance between the separate aluminum electrolytic capacitors and the metal heat-conducting base component in the aluminum electrolytic capacitor module should be minimized, which requires a decrease of the thickness of the heat-conducting silica gel; so it will be undoubtedly increase the technical difficulty to make a balance between the reliability and electrical performance optimization of the capacitor module; and the use of higher-cost high-heat-conductivity silica gel to optimize the electrical performance of the aluminum electrolytic capacitor module will increase the cost of the aluminum electrolytic capacitor module.

When the aluminum electrolytic capacitor module is fabricated, positive and negative leads or soldering terminals of all the separate aluminum electrolytic capacitors need to be welded to a positive conducting copper busbar and a negative conducting copper busbar respectively, and the positive conducting copper busbar and the negative conducting copper busbar should be insulated to guarantee the safety. Because the positive poles and negative poles of the small aluminum electrolytic capacitors are close to each other, the positive conducting copper busbar and the negative conducting copper busbar should be as close to each other as possible, which makes the fabrication difficulty high; the rejection rate in actual fabrication is high, and risk of electric shocks to test workers is high; and the product has a high failure rate and other problems in use. Therefore, it is necessary to develop a novel product design to solve the above problems to improve product quality.

Due to the limitation of the above specifical conditions, the aluminum electrolytic capacitor module has the problems of complex internal integrated structure, high fabrication difficulty, high technical risks, and the like.

### SUMMARY OF THE PRESENT INVENTION

The invention provides a design scheme of a centralized-insulation aluminum electrolytic capacitor module, which is simple in structure and fabrication process; a busbar terminal board is injection-molded or bonded integrally, such that the safety is improved; particularly, secondary sealing is performed on seal positions of aluminum electrolytic capacitors, such that the operating life of the aluminum electrolytic capacitors is prolonged; a temperature sensor is arranged to indirectly monitor the average operating temperature rise of separate aluminum electrolytic capacitor modules to predict the operating life; and Y capacitors are integrated in the aluminum electrolytic capacitor module, such that the EMC performance of a power supply device is optimized; and design and use problems in heat dissipation and installation of the aluminum electrolytic capacitor module in a power supply device with a protection level over IP65 are solved.

The specific solution is as follows:

An aluminum electrolytic capacitor integrated module comprises a heat-conducting insulation gasket, separate aluminum electrolytic capacitors, a metal heat-conducting base component, an insulative housing, and an air cavity of an internal pressure release mechanism defined by the metal heat-conducting base component and the insulative housing, wherein the aluminum electrolytic capacitor module is formed by closely assembling the separate aluminum electrolytic capacitors and the metal heat-conducting base component, and realizes centralized insulation and heat dissipation to the outside by means of the heat-conducting insulation gasket.

Wherein, the separate aluminum electrolytic capacitors and the metal heat-conducting base component are assembled closely and are not insulated from each other, and the separate aluminum electrolytic capacitors and the heat-conducting base component may form multiple assembly units, and form a series or multi-stage series-parallel circuit through an electrical connection busbar.

Further, the contact area between surfaces of aluminum shells of the aluminum electrolytic capacitors and the metal heat-conducting base component should be as large as possible to facilitate heat dissipation and reduce heat resistance;

Specifically, the separate aluminum electrolytic capacitors and the heat-conducting base component are closely assembled by means of cell structures, and the circumferential surfaces of the aluminum shells of the aluminum electrolytic capacitors are entirely disposed in circular holes of the heat-conducting base component, such that the contact area is maximized;

Further, the surfaces of the aluminum shells of the aluminum electrolytic capacitors and the metal heat-conducting base component are assembled as closely as possible to reduce heat resistance and improve heat-conducting efficiency;

Further, the surfaces of the aluminum shells of the aluminum electrolytic capacitors are partially welded on the metal heat-conducting base component, or are in interference fit the metal heat-conducting base component, such that assembly is closer.

Further, to lower the assembly difficulty, the conicity of assembly holes of the metal heat-conducting base component is designed to be the same as the conicity of the aluminum shells of the aluminum electrolytic capacitors, and the aluminum electrolytic capacitors are pressed into the assembly holes of the metal heat-conducting base component from large-opening sides of the assembly holes;

Further, the aluminum electrolytic capacitors and the metal heat-conducting base component are assembled by means of cell structures, and secondary sealing is performed on sealed positions, where poles are led out, of the separate aluminum electrolytic capacitors in cells of the metal heat-conducting base component with a sealing material such as epoxy resin, such that the sealing performance of the sealed positions of the aluminum electrolytic capacitors is enhanced, and the operating service life of the capacitors is prolonged.

Further, a temperature sensor is disposed on the metal heat-conducting base component, and the temperature sensor is disposed a surface of the heat-conducting base component in an insulative manner or is disposed in the metal heat-conducting base component;

Specifically, the metal heat-conducting base component is closely attached to the surfaces of the separate aluminum electrolytic capacitors to absorb the heat loss of the capacitors to make a balance, and the temperature sensor indirectly monitors the average operating temperature rise of all the separate aluminum electrolytic capacitors through the metal heat-conducting base component;

Further, the electrical connection busbar is integrally designed and manufactured by integrally injection-molding or bonding conducting copper bars and an injection-molded member, and an integrated and independent busbar terminal board is formed by covering of the injection-molded member and internal isolation and insulation;

Specifically, on the independent and integrated busbar terminal board, the positions where the positive and negative poles or soldering terminals of the separate aluminum electrolytic capacitors are welded to the conducting copper bars and the position where an external electrical connection terminal of the aluminum electrolytic capacitor module is led out of the injection-molded member are hollowed out;

Specifically, positions where voltage-sharing resistors or other necessary circuit elements are welded of the integrated and independent busbar terminal board of a multi-stage series-parallel circuit structure are hollowed out;

Specifically, the shape of the integrated and independent busbar terminal board can be changed adaptively according to the structural outline of the aluminum electrolytic capacitor module and the installation position, angle and distance of the electrical connection terminal.

Wherein, the metal heat-conducting base component has negative charges, has one structural surface used as am aluminum electrolytic capacitor module mounting surface, and realize centralized insulation and heat dissipation through the heat-conducting insulation gasket.

Further, the structural surface, used as the aluminum electrolytic capacitor module mounting surface, of the metal heat-conducting base component should be as large as possible on the premise of facilitating installation to improve the heat conduction and dissipation efficiency;

Further, the heat-conducting insulation gasket is preferably made of thinner heat-conducting insulation ceramic or silica gel with higher heat conductivity to improve the heat conduction efficiency of the capacitor module.

Wherein, an assembly of the aluminum electrolytic capacitors and the metal heat-conducting base component is covered and safely insulated by the insulative housing, and defines an air cavity and is provided with a pressure outlet to form an internal pressure release mechanism of the capacitor module.

Further, the internal pressure release mechanism formed by the air cavity and the pressure outlet is started in case of a fault of the separate aluminum electrolytic capacitors, and the air cavity can protect the aluminum electrolytic capacitor module against short circuits caused by leaking of an electrolyte with negative charges;

Specifically, multiple assembly units formed by the separate aluminum electrolytic capacitors and the metal heat-conducting base component are insulated by the insulative housing, a multi-stage series-parallel circuit is formed through an electrical connection busbar, a pressure release mechanism formed by corresponding independent air cavities and pressure outlets is arranged in the insulative housing to prevent short circuits between the assembly unitscaused by upward or downward leaking of the electrolyte with the negative charges.

Wherein, the aluminum electrolytic capacitor module further comprises an affiliated radiator mounted on the capacitor module mounting surface through the heat-conducting insulation gasket;

Specifically, the affiliated radiator may be radiators of any structure, shape and type;

Specifically, the affiliated radiator is fastened on the capacitor module with screws or is pressed on the capacitor module with clips.

Further, the affiliated radiator is an auxiliary radiator co-existing with a main radiator in a power supply device, and is configured to cool a power semiconductor device and the capacitor module;

Further, the auxiliary radiator is part of a power device housing, cooling fins are disposed on an outer side of the auxiliary radiator, and an inner side of the auxiliary radiator is assembled on the capacitor module through the heat-conducting insulation gasket in an insulative manner;

Specifically, the metal power device housing can be used as an auxiliary radiator;

Specifically, the auxiliary radiator, as a power supply radiator, is arranged in parallel with a main radiator of a power supply, or is disposed on any one of side faces and front side of the power supply;

Specifically, the auxiliary radiator is assembled on the aluminum electrolytic capacitor module through fastening screws or clips, and is insulated and isolated from the metal heat-conducting base component of the capacitor module.

Wherein, an electrical connection terminal of the aluminum electrolytic capacitor module is electrically connected to a power main board or a conducting copper bar.

Further, the length, position and shape of the electrical connection terminal can be changed according to the specific installation condition to satisfy installation requirements of the electrical connection terminal;

Specifically, the electrical connection terminal is electrically connected to the power main board or the conducting copper bar by welding with welding pins or by fastening with copper screws;

Wherein, the aluminum electrolytic capacitor is integrated with a Y capacitor to prevent polarization of aluminum foil of the negative poles of the aluminum electrolytic capacitors, so as to prolong the service life of the aluminum electrolytic capacitors, improve the reliability of the aluminum electrolytic capacitor, and retain EMI electromagnetic interference of a power electronic system to improve EMC reliability;

Specifically, positive and negative poles of the separate aluminum electrolytic capacitors are electrically connected to a positive conducting copper bar and a negative conducting copper bar of the busbar terminal board correspondingly, a positive pole of the Y capacitor is electrically connected to a ground wire of the positive conducting copper bar a ground wire of the negative conducting copper bar, and the Y capacitor and the aluminum electrolytic capacitors form a parallel circuit structure on the positive and negative conducting copper bars;

Specifically, the Y capacitor is disposed on the busbar terminal board or in the metal heat-conducting base component, and a ground wire terminal is disposed on the busbar terminal board or on the insulative housing.

The aluminum electrolytic capacitor integrated module can adopt a water-cooled radiator, thus breaking through the limitation of air cooling of traditional aluminum electrolytic capacitors, and the active heat dissipation power can be designed, thus satisfying the technical requirement for liquid cooling of existing wind power converters or photovoltaic inverters; in an aright protection application scenario with a protection level over IP65, the affiliated radiator is used for cooling, and secondary sealing is performed on capacitors, thus breaking through the 15-year upper limit of the design operating life of aluminum electrolytic capacitors and satisfying long-life application requirements such as the application requirement for 25-year life of outdoor string photovoltaic inverters; and the aluminum electrolytic capacitor module greatly promotes the development of the application of aluminum electrolytic capacitors.

Compared with aluminum electrolytic capacitor modules filled with heat-conducting silica gel, the technical solution of the invention eliminates the dispersed insulation design based on low-heat-conductivity insulating and heat-conducting silica gel filled in separate aluminum electrolytic capacitors, the heat-conducting insulation gasket with higher heat conductivity is used for centralized insulation and heat dissipation, such that the heat dissipation efficiency of the capacitor module is improved, and the electrical performance is optimized, and particularly, the fabrication process of the capacitor module is simplified, and the fabrication efficiency is improved; the integral design of the busbar terminal board improves the safety and insulating reliability of the aluminum electrolytic capacitor in use, the number of structural parts is reduced, and material and process costs are reduced; the fabrication process of the aluminum electrolytic capacitor module is simplified, the fabrication time is shortened, and economic benefits are increased; defective products are avoided in the production process, thus reducing the mass production cost of products; the temperature sensor of the aluminum electrolytic capacitor module can realize high-temperature operating protection and monitoring of the aluminum electrolytic capacitor module and can predict the operating life and temperature of the aluminum electrolytic capacitor module; the auxiliary radiator is arranged for the power supply device to realize centralized insulation and heat dissipation of the capacitor module, and the heat loss of power busbar capacitors is dissipated out of the airtight housing, such that the temperature rises and heat accumulation in the power device housing are effectively reduced, the failure rate of the power supply is decreased, the operating life of the capacitor module is prolonged, and it is ensured that the power supply has a high dust-proof and damp-proof protection level; the aluminum electrolytic capacitor module is integrated with the Y capacitor, such that the problem of reverse pulse current formation of negative foil by the electrolyte in the aluminum electrolytic capacitors under the action of high-order harmonics on the power DC busbar is effectively solved, and earlier aging of the aluminum electrolytic capacitors is avoided; and the Y capacitor can effectively restrain common mode interference of power electronic devices, thus improving the EMC reliability of a whole power electronic system.

### BRIEF DESCRIPTION OF THE DRAWINGS

The above and other features of the invention will be described below in conjunction with accompanying drawings.

FIG. 1 is a schematic diagram of separate aluminum electrolytic capacitors and a metal heat-conducting base component which are assembled through cell structures;

FIG. 2 is an assembly diagram of an aluminum electrolytic capacitor module;

FIG. 3 is a combined structural view of an air cavity of an internal pressure release mechanism;

FIG. 4 is a schematic diagram of secondary sealing of separate aluminum electrolytic capacitors;

FIG. 5 is a combined structural view of a busbar terminal board;

FIG. 6 is an outside view of an integrally injection-molded busbar terminal board;

FIG. 7 is a combined outside view of an NTC temperature sensor;

FIG. 8 is an installation diagram of the NTC temperature sensor;

FIG. 9 is a schematic diagram of centralized insulation, heat dissipation and installation of the aluminum electrolytic capacitor module;

FIG. 10 is a schematic diagram of an external radiator disposed in a power supply device of the capacitor module;

FIG. 11 is a circuit diagram of a Y capacitor of the capacitor module;

FIG. 12 is an outside view of a Y capacitor module;

FIG. 13 is a schematic diagram of the Y capacitor module installed in the capacitor module;

### REFERENCE SIGNS IN THE FIGURES

1, separate aluminum electrolytic capacitor
11, positive and negative lead terminals
2, metal heat-conducting base component
21, aluminum electrolytic capacitor mounting cell
22, capacitor module insulation, heat-dissipation and installation surface
23, affiliated radiator mounting screw hole
24, housing mounting guide hole
25, NTC temperature sensor socket
26, Y capacitor module socket
27, flat sealing material layer; 28, sealing material space
3, combined busbar terminal board
31, injection-molded housing baes plate
311, NTC temperature sensor holder
312, Y capacitor module holder
313, positive and negative lead through-holes of capacitors
32, positive busbar
321, positive terminal of capacitor module
322, capacitor positive lead welding hole
322, capacitor negative lead welding hole
33, positive and negative busbar insulation board 33
331, capacitor positive and negative lead through-hole
34, negative busbar
341, negative terminal of capacitor module
342, capacitor negative lead welding hole
343, capacitor positive lead welding hole
35, injection-molded upper cover plate
36, capacitor module label paper
37, integrated busbar terminal board
371, insulative injection-molded member
372, recess for welding positive and negative leads of capacitor
4, insulative housing
41, pressure outlets
42, housing mounting guide pillar
43, pressure release cavity sealing rib
44, pressure release cavity pillar
45, positive and negative terminal mounting base of capacitor module
46, NTC temperature sensor wiring notch
47, wiring terminal notch of Y capacitor module
48, mounting screw through-hole
49, insulating bushing of flange surface of screw hole
5, NTC temperature sensor packaging module
51, NTC temperature sensor packaging probe
52, connector terminal
6, Y capacitor module;
61, Y capacitor circuit connection packaging module
611, Y capacitor
62, ground wire terminal base
63, positive lead of Y capacitor bank
64, negative lead of Y capacitor bank
65, ground wire;
7, heat-conducting insulation gasket
71, mounting screw through-hole
8, affiliated (auxiliary) radiator
81, radiator fin
82, capacitor module screw mounting hole
83, insulative mounting flange gasket
9, main radiator
91, main radiator fin
92, IGBT module
93, power protection housing
94, affiliated radiator mounting hole

### DETAILED DESCRIPTION OF THE PREFERRED EMBODIMENT

The invention will be described in further detail below in conjunction with specific embodiments and accompanying drawings.

In the following embodiments, many detailed descriptions are provided to gain a better understanding of the invention. However, those skilled in the art can easily appreciate that part of the features in the following embodiments can be replaced with other materials or methods, or be omitted. In some cases, some relevant operations are not shown or described in the specification to prevent core parts of the application from being ignored. Those skilled in the art can completely understand relevant operations with reference to the descriptions in the specification and common knowledge in the art.

### Preferred Embodiment

Separate aluminum electrolytic capacitors 1 without insulating bushings are disposed in cells 21 of a metal heat-conducting base component 2, and in order to maximize the heat dissipation efficiency, the circumferential surfaces of the cells 21 and the surfaces of aluminum shells of the aluminum electrolytic capacitors 1 are closely assembled in an interference fit manner.

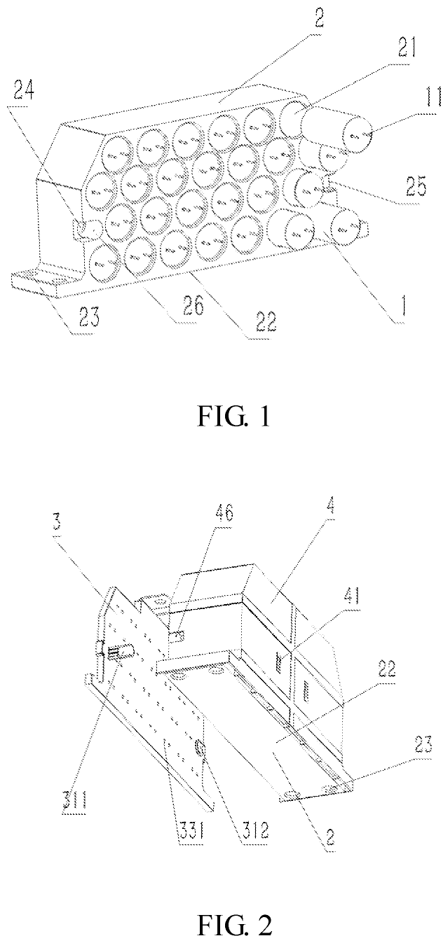

A lower side of the metal heat-conducting base component 2 is used as an aluminum electrolytic capacitor module mounting surface 22, affiliated radiator 8 mounting screw holes 23 are distributed in the aluminum electrolytic capacitor module mounting surface 22, insulative housing 4 mounting guide holes 24 are formed in two sides of the metal heat-conducting base component 2, on a back side of the metal heat-conducting base component 2 (the side where an air cavity of a pressure release mechanism is located), insulative housing 4 mounting pillars 42 are matchingly assembled in the guide holes 24, and an NTC temperature sensor socket 25 and a Y capacitor module socket 26 are disposed on a front side of the metal heat-conducting base component 2 (the side where a busbar terminal board 3 is located). (FIG. 1)

An assembly of the separate aluminum electrolytic capacitors 1 and the metal heat-conducting base component 2 is covered and insulated by an insulative housing 4 from the back; at the rear end of the metal heat-conducting base component 2 and one side of a pressure outlet in the top of the separate aluminum electrolytic capacitors 1, a pressure release air cavity used for air ventilation is formed between the insulative housing 4 and the end face of the metal heat-conducting base component 2, pressure outlets 41 are correspondingly formed in the insulative housing 4, and the insulative housing 4 is assembled in a mortise and tenon manner through the mounting pillars 42 on the two sides of the interior of the insulative housing 4 and the guide holes 24 formed in the two sides of the metal heat-conducting base component 2. (FIG. 2)

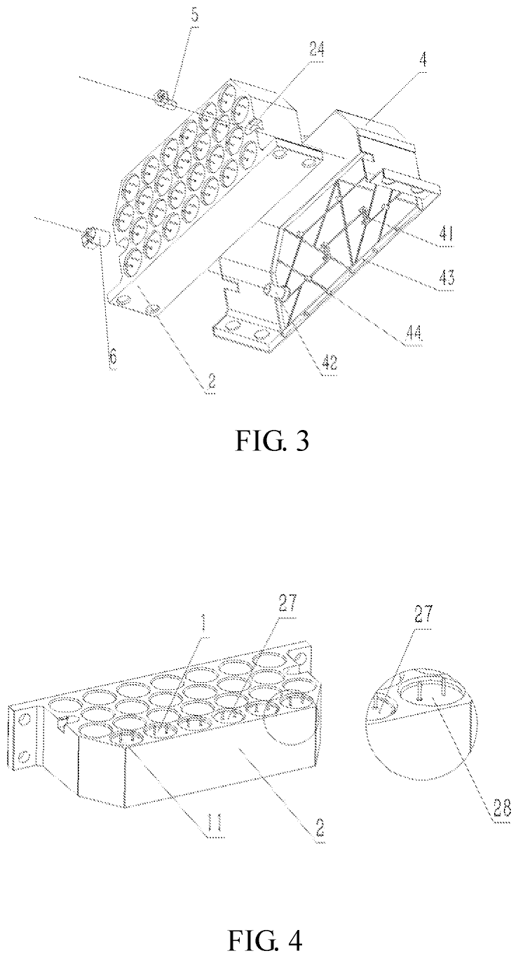

The pressure release air cavity defined by the insulative housing 4 and the metal heat-conducting base component 2 is sealed end-to-end, that is, sealing ribs 43 and pressure release cavity pillars 44 are disposed at positions, corresponding to end faces of the metal heat-conducting base component 2, of the insulative housing 4, and the cavity is sealed with a sealing material such as a sealant, such that external short circuits caused by leaking of an electrolytes with negative charges in case of a fault of the separate aluminum electrolytic capacitors 1 are avoided. (FIG. 3)

Positive and negative lead terminals 11 of the separate aluminum electrolytic capacitors 1 penetrate through positive and negative lead through-holes 313 in an injection-molded housing base plate 31 electrically connected to a positive busbar 32 and a negative busbar 34 by welding; an NTC temperature sensor holder 311 and a Y capacitor module holder 312 are disposed at positions, corresponding to the NTC temperature sensor socket 25 and the Y capacitor module socket 26 at the guide holes 24 of the metal heat-conducting base component 2 and the guide holes 24, of the injection-molded housing base plate 31, and an NTC temperature sensor 5 and a Y capacitor module 6 are disposed in the NTC temperature sensor holder 311 and the Y capacitor module holder 312, and an aluminum electrolytic capacitor module is formed after assembly. (FIG. 2 and FIG. 3)

To guarantee better insulation between the positive and negative lead terminals 11 of the separate aluminum electrolytic capacitors 1 and the metal heat-conducting base component 2 and to better seal rubber sealed positions of the separate aluminum electrolytic capacitors 1, epoxy resin is injected on sealing rubber on the positive and negative lead terminals 11 of the separate aluminum electrolytic capacitors 1 and in aluminum electrolytic capacitor mounting cells 21 in the metal heat-conducting base component 2 to form a sealed flat structure, thus ensuring that the aluminum electrolytic capacitors have better insulating reliability and longer sealing time. (FIG. 4)

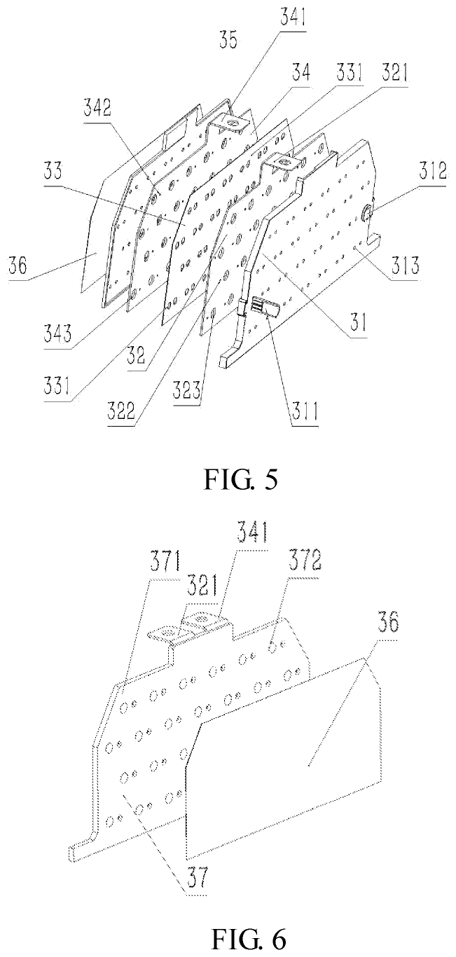

As for the combined busbar terminal board 3, the negative busbar 34 is placed in the injection-molded housing base plate 31, then insulating paper 33 is placed in the injection-molded housing base plate 31, then the positive busbar 32 is placed in the injection-molded housing base plate 31, and the positive busbar 32 and the negative busbar 34 are electrically connected to the positive and negative leads 11 of the separate aluminum electrolytic capacitors 1 respectively by welding, such that the positive and negative busbars 32 and 34 and the positive and negative leads 11 are insulated, a complete stacked busbar structure is formed; and finally, an upper cover plate 35 on the outer side is placed in the injection-molded housing base plate 31 to guarantee insulation from the outside, and product label paper 36 indicating performance parameters such as the specification and model of the capacitor module adheres to the outer side of the injection-molded upper cover plate 35, such that the combined busbar terminal board of the aluminum electrolytic capacitor module is formed. (FIG. 5)

The positive busbar 32 and the negative busbar 34 of the integrally injection-molded busbar terminal board 37 are limited and then placed in an plastic mold, the injection-molded housing base plate 31, a positive and negative busbar insulation board 33 and an injection-molded upper cover plate 35 are integrally manufactured through injection molding of an injection molding device; to electrically connect the leads 11 of the separate aluminum electrolytic capacitors 1 to the corresponding positive busbar 32 and negative busbar 34 by welding, recesses are formed in welded positions of an injection-molded member of the busbar terminal board 37 to guarantee reliable insulation of the positive busbar 32 and the negative busbar 34, and recesses are also formed for positive terminals 321 and negative terminals 341 for realize electrical connection with the outside; and in order to guarantee the insulating safety, welded positions of the injection-molded member are covered with capacitor module label paper 36 with better insulating performance. (FIG. 6)

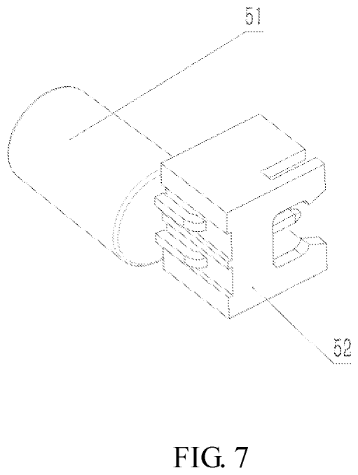

An NTC temperature sensor packaging module 5 is composed of a temperature sensor packaging probe 51 and a terminal connector 52, and the probe may be packaged and insulated with epoxy resin, metal, glass, a film or other materials. (FIG. 7)

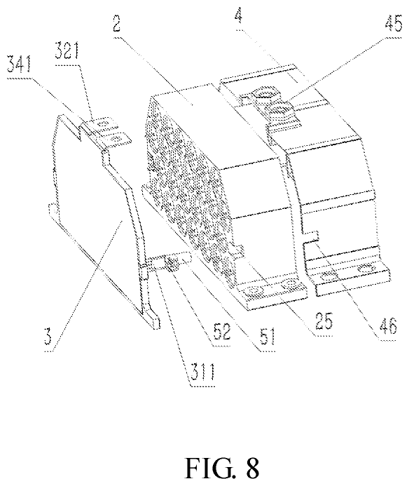

The NTC temperature sensor packaging module 5 is disposed in an NTC temperature sensor packaging module holder 311 of the busbar terminal board 3, the busbar terminal board 3 is assembled, the connector 52 of the NTC temperature sensor packaging module 5 is clamped in the NTC temperature sensor holder 25 of the metal heat-conducting base component 2, the temperature sensor packaging probe 51 is placed in the housing mounting guide holes 24 in the metal heat-conducting base component 2, and to realize firm assembly, the outside of the temperature sensor probe 51 in the guide holes 24 is fixed with glue or clips. (FIG. 8)

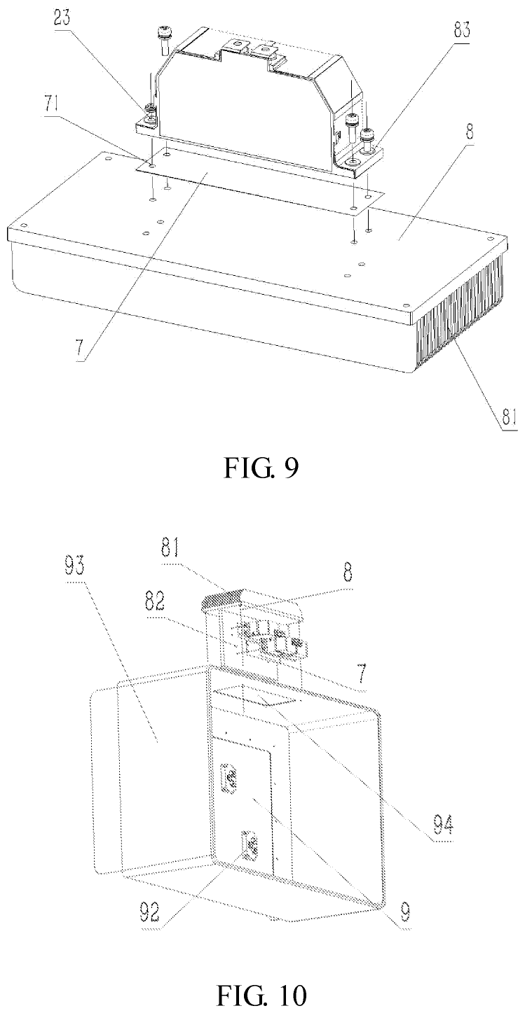

One structural surface of the metal heat-conducting base component 2 is used as the capacitor module mounting surface 22, and screw mounting holes 23 are distributed in the capacitor module mounting surface 22 and are used for fixedly assembling an affiliated radiator 8; and a heat-conducting insulation gasket 83 is disposed between the capacitor module mounting surface 22 and the affiliated radiator 8 for insulation and heat conduction; and the mounting screws are insulated from the metal heat-conducting base component 2 through an insulative mounting flange gasket 83. (FIG. 9)

A heat-conducting insulation gasket 7 and the aluminum electrolytic capacitor module are stacked on the affiliated radiator 8, and mounting screws penetrate through the insulative mounting flange gasket 83, aluminum electrolytic capacitor module mounting screw holes 23, and heat-conducting insulation gasket screw holes 71 to be screwed, fixed and assembled on the affiliated radiator 8, such that the metal heat-conducting base component 2 of the aluminum electrolytic capacitor module is isolated from the affiliated radiator 8, and a better heat conduction and dissipation effect of the aluminum electrolytic capacitor module is realized through the heat-conducting insulation gasket 7. (FIG. 9)

The positive terminal 321 and the negative terminal 341 are led out from the top of the capacitor module, and the position and shape of the terminals can be changed as the case may be to satisfy the requirement for electrical connection. (FIG. 9)

A main radiator 9 is disposed on the back of a power protection housing 93, main radiator fins 91 are disposed on the outer side of the main radiator 9, an IGBT module 92 is mounted on the inner side of the main radiator 9, affiliated radiator mounting holes 94 are formed in the upper side of the main radiator and the upper surface of the protection housing 93 and are used for assembling the affiliated radiator 8, cooling fins 81 are disposed on an outer side of the affiliated radiator 8, and the capacitor module is mounted on an inner side of the affiliated radiator 8. (FIG. 10)

The main radiator 9 is isolated from the affiliated radiator, such that heat generated by the IGBT module on the main radiator 9 is prevented from being dissipated through the affiliated (auxiliary) radiator 8, which may otherwise exert a high-temperature influence on the capacitor module. (FIG. 10)

The auxiliary radiator 8, as one part of the power protection housing 93, can protect a power supply in the power protection housing 93, the cooling fins on the outer side of the auxiliary radiator 8 are located in a low-temperature environment on the outer side of the power protection housing, and the inner side of the auxiliary radiator 8 is located in a high-temperature environment in the power protection housing 93. (FIG. 10)

The auxiliary radiator 8 is located above the main radiator 9, such that the affiliated radiator fins 81 will not be affected by the high temperature of the main radiator fins 91. (FIG. 10)

Capacitor module mounting and fixing screw holes 82 are formed in a plane, located on the inner side of the power protection housing 93, of the auxiliary radiator 8, and the auxiliary radiator 8 is mounted and fixed through screws penetrating through the heat-conducting insulation gasket through-holes and the capacitor module mounting holes 23. (FIG. 10)

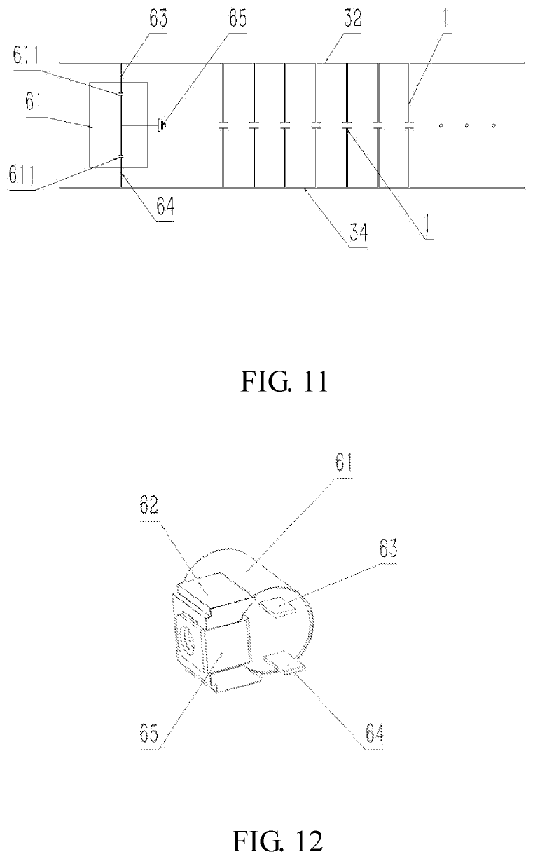

The aluminum electrolytic capacitor module integrated with Y capacitors is formed by parallel connection of multiple separate aluminum electrolytic capacitors 1 and two Y capacitor 611 banks connected in series, wherein the two Y capacitor 611 banks connected in series are connected between the positive conducting copper bar 32 and the negative conducting copper bar 34, and a ground wire 65 is led out from the two Y capacitor 611 banks connected in series. (The circuit structure is shown in FIG. 11)

The ground wire 65, a positive lead 63, a negative lead 64 and Y capacitors 611 form a complete circuit structure, and are integrated to form a Y capacitor circuit connection packaging module 61, which forms a Y capacitor module with a ground terminal base 62. (FIG. 12)

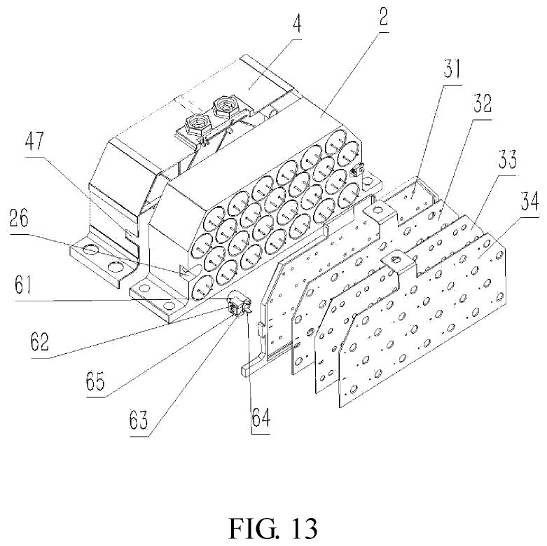

The Y capacitor module is mounted, the positive lead 63 corresponds to the positive conducting copper bar 32, and the negative lead 64 penetrates through a positive conducting copper bar 32 through-hole to be electrically connected to the negative conducting copper bar 34 by welding. (FIG. 13)

When the capacitor module is assembled, a ground wire terminal base 62 is clamped in a Y capacitor module socket 26 of the metal heat-conducting base component 2, and the Y capacitor circuit connection packaging module 61 is disposed in a housing mounting guide hole 24 of the metal heat-conducting base component 2. (FIG. 13)

When the aluminum electrolytic capacitor module is assembled, the positive terminal 321 and the negative terminal 341 are electrically connected to a positive power busbar and a negative power busbar of a power electronic system respectively, and the ground terminal 65 is electrically connected to a ground wire of the power electronic system.

1-42. (canceled)

43. An aluminum electrolytic capacitor integrated module,
comprising separate aluminum electrolytic capacitors, a heat-conducting base component, a heat-conducting insulation gasket, a housing, an affiliated bus terminal board and an affiliated radiator, wherein the aluminum electrolytic capacitor integrated module is formed by closely assembling the separate aluminum electrolytic capacitors and the heat-conducting base component; the heat-conducting base component is of any shape, size and structure, and forms a compact assembly structure together with the separate aluminum electrolytic capacitors, the separate aluminum electrolytic capacitors are aluminum electrolytic capacitor products adopting lead-type, snap-in or screw-type lead-out structures, the separate aluminum electrolytic capacitors and the heat-conducting base component are closely assembled by means of cell or semi-cell structures, circumferential surfaces of aluminum shells of the aluminum electrolytic capacitors are entirely or partially disposed in circular holes or semicircular holes of the heat-conducting base component, the separate aluminum electrolytic capacitors and the heat-conducting base component form multiple assembly units, and form the aluminum electrolytic capacitor integrated module of a series circuit structure or a multi-stage series-parallel circuit structure by designing an electrical connection busbar, secondary sealing is performed on seal positions of positive and negative poles of the separate aluminum electrolytic capacitors with a sealing material such as epoxy resin, and the secondary sealing is performed by means of the cells of the heat-conducting base component after the aluminum electrolytic capacitor integrated module is assembled, or the secondary sealing is performed on the separate aluminum electrolytic capacitors separately and then the aluminum electrolytic capacitor integrated module is assembled; an auxiliary structure is disposed on an inner or outer surface of the housing to clamp or fix the housing or the capacitor integrated module, an air cavity and a pressure outlet of an internal pressure release mechanism are defined by the housing and the heat-conducting base component, the internal pressure release mechanism is started in case of a fault of the separate aluminum electrolytic capacitors, and the air cavity protects the aluminum electrolytic capacitor integrated module against short circuits caused by leaking of an electrolytes with negative charges; in the case where the separate aluminum electrolytic capacitors and the heat-conducting base component form multiple assembly units, corresponding independent air cavities and pressure outlets are arranged to prevent short circuits between the assembly units caused by upward or downward leaking of the electrolyte with the negative charges; auxiliary structures such as holes or slots are disposed on the heat-conducting base component to clamp or fix the housing, a bus terminal board, and other structural components; the integrated bus terminal board of the aluminum electrolytic capacitor integrated module comprises electrical connection copper bars and an injection-molded member, the copper bars are electrically conductive copper bars for realizing parallel connection, series connection, or multi-stage series-parallel connection of the separate aluminum electrolytic capacitors, the electrical connection copper bars and injection-molding materials for insulating and isolating the electrical connection copper bars are covered by the injection-molded member, the electrically conductive copper bars and the injection-molded member form an independent integrated structural component by injection molding or bonding, the injection-molded member is provided with holes corresponding to some positions of the integrated bus terminal board to expose the electrically conductive copper bars to allow positive and negative leads or soldering terminals of the separate aluminum electrolytic capacitors to be welded thereto, and welding positioning injection-molding holes for voltage-sharing resistors or other necessary circuit elements are formed in the bus terminal board; the aluminum electrolytic capacitor integrated module realizes centralized insulation and heat dissipation to the outside by means of the heat-conducting insulation gasket, wherein the heat-conducting insulation gasket is made of heat-conducting insulation ceramic, silica gel, or other heat-conducting insulation materials, is flake-like to reduce the thickness and heat resistance, is in a groove shape or other shapes beneficial to the structural design of the integrated module, and is assembled on the aluminum electrolytic capacitor integrated module when installed or integrated with the heat-conducting base component or the affiliated radiator; the affiliated radiator is mounted on the capacitor integrated module through the heat-conducting insulation gasket, is an air-cooled finned radiator, a liquid-cooled radiator, or a heat transfer and conduction object such as a power device housing, and is fastened on the capacitor integrated module with screws or pressed on the capacitor integrated module with clips, the affiliated radiator is a dedicated radiator of the capacitor integrated module, a radiator shared by the capacitor integrated module and other devices, or an auxiliary radiator shared by multiple capacitor integrated modules, and the affiliated radiator in the power device housing may be in different special shapes to facilitate the layout of the aluminum electrolytic capacitor integrated module in the power device housing; the aluminum electrolytic capacitor integrated module is integrated with a temperature sensor and a Y capacitor, wherein the temperature sensor is an NTC or PTC thermistor, a thermocouple of a K type, a J type or other specifications, or other temperature sensing devices which are made of a film, epoxy, glass, metal or any other materials and packaged in any form, and is disposed a surface of the heat-conducting base component in an insulative manner or disposed in the heat-conducting base component to indirectly monitor an average operating temperature rise of all the separate aluminum electrolytic capacitors; the Y capacitor is a ceramic capacitor, a thin-film capacitor, or other capacitors, positive and negative poles of the Y capacitor are electrically connected to a ground wire, or the positive or negative pole of the Y capacitor is electrically connected to the ground wire, the positive and negative poles of the Y capacitor (connected in series) and the positive and negative poles of the aluminum electrolytic capacitors form a parallel circuit structure, one Y capacitor is electrically connected to a positive bus, a negative bus and a ground wire or multiple Y capacitors (groups) connected in parallel are electrically connected to the positive bus, the negative bus and the ground wire, and the Y capacitor is disposed inside or outside the aluminum electrolytic capacitor integrated module, the Y capacitor (group) is electrically connected to a power main board or a bus copper bar by welding, or by tightening with screws synchronously with the aluminum electrolytic capacitor integrated module, and the ground wire of the Y capacitor is a metal wire or a metal conducting bar in any shape, and is directly led out to be connected to a complete ground wire or is connected to the complete ground wire through an adapter terminal.

44. The aluminum electrolytic capacitor integrated module according to claim 43, wherein the separate aluminum electrolytic capacitors and the heat-conducting base component are closely assembled in a manner that the circular holes (cells) of the heat-conducting base component are in taper fit with the aluminum shells of the aluminum electrolytic capacitors, such that the assembly difficult is lowered.

45. The aluminum electrolytic capacitor integrated module according to claim 43, wherein an assembly formed by the separate aluminum electrolytic capacitors and the heat-conducting base component is covered and insulated by the housing, and the assembly is entirely or partially covered with one or more materials such as plastic or three-proofing (insulating) paint.

46. The aluminum electrolytic capacitor integrated module according to claim 43, wherein the heat-conducting base component is entirely or partially made of heat-conducting ceramic or silica gel.

47. The aluminum electrolytic capacitor integrated module according to claim 43, wherein a heat-conducting component allowing the temperature sensor to be disposed on a surface thereof in an insulative manner or disposed therein is separately disposed in the aluminum electrolytic capacitor integrated module.

48. The aluminum electrolytic capacitor integrated module according to claim 43, wherein an electrical connection terminal led out of the integrated bus terminal board has a length and shape capable of being adaptively adjusted according to an outline structure of the aluminum electrolytic capacitor integrated module and an installation position, angle and distance of the electrical connection terminal, to be electrically connected to a power main board or the electrically conductive copper bar adaptively.

49. The aluminum electrolytic capacitor integrated module according to claim 43, wherein one or more groups (strings) of positive and negative bus circuits are disposed in the integrated bus terminal board.

50. The aluminum electrolytic capacitor integrated module according to claim 43, wherein an auxiliary structure is disposed on an inner or outer surface of the integrated bus terminal board to clamp or fix the bus terminal board or the capacitor integrated module.

51. The aluminum electrolytic capacitor integrated module according to claim 43, wherein the positive and negative poles of all the separate aluminum electrolytic capacitors of the aluminum electrolytic capacitor integrated module are directly connected to a power main circuit PCB to be electrically connected to an IGBT/MOSFET module and a power bus, that is, a suitable PCB is used as the bus terminal board.

52. The aluminum electrolytic capacitor integrated module according to claim 43, wherein fins of the affiliated radiator are disposed outside a power device housing, the capacitor integrated module is mounted in the airtight power device housing, and the affiliated radiator is used as an auxiliary radiator of a power device of a high protection level and air tightness level.

53. The aluminum electrolytic capacitor integrated module according to claim 43, wherein the auxiliary radiator and a main radiator are disposed on a same plane of the power device housing or on different planes of the power device housing.

54. The aluminum electrolytic capacitor integrated module according to claim 52, wherein the auxiliary radiator and a main radiator are disposed on a same plane of the power device housing or on different planes of the power device housing.
